(19) United States
(12) Patent Application Publication
(10) Pub. No.: US 2007/0150147 A1
(43) Pub. Date: Jun. 28, 2007

(54) Compactor using compaction value targets

(76) Inventors: Terry L. Rasmussen, Princeville, IL (US); David R. Schricker, Princeville, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/315,263

(22) Filed: Dec. 23, 2005

(51) Int. Cl. G06F 19/00

(52) U.S. Cl. 701/50; 701/213

(57) ABSTRACT

A compaction monitoring system for a compactor has one or more sensors, a positioning system and a controller. The sensors are configured to transmit signals representative of one or more characteristics of a material related to a compaction value of the material. The positioning system may be configured to transmit a location signal representative of a position of the compactor. The controller may be configured to receive the signals from the one or more sensors, determine compaction values of the material based on the signals from the one or more sensors using a proof-rolling method, and determine the position of the compactor based on the location signal transmitted by the positioning system. The controller may also be configured to generate a compaction value profile based on compaction values of the material and the position of the compactor, compare the compaction value profile to stored compaction value target information, determine a difference between the compaction value profile and the compaction value target information, and output information based on the difference between the compaction value profile and the compaction value target information.

### TECHNICAL FIELD

The present disclosure is directed to a compactor, and more particularly, to a compactor using compaction value targets.

### BACKGROUND

Preparation of roadways, building sites, embankments and other surfaces often requires compaction to produce desired material properties. To facilitate material compaction, compactors are often employed to compact soil, gravel, asphalt, and other materials. Such compactors may include, for example, rotating drum compactors in which one or more rotatable drum assemblies roll over the material to be compacted. The drum assembly, or roller, may include a static roller system in which the weight of the compactor and drum produces the compaction. Alternatively, compactors may include a vibratory mechanism having weights arranged within an interior cavity of the drum for inducing vibrations to enhance the compaction process. The vibratory mechanism may include a range of frequency and/or amplitude settings selected based on the characteristics of the material to be compacted.

The desired degree of material compaction may vary based on the type of material being compacted and/or the conditions of material, such as, for example, moisture content and temperature. After completion of a compaction process, the degree of material compaction may be measured and evaluated for conformity with job specifications. Traditional methods for determining material compaction have included density measurements and physical testing. Density measurements may be conducted using an instrument, such as a nuclear density meter. Physical testing may be performed by inspecting surface deformation produced by a truck, a studded compactor, or a penetrometer. However, these methods may only evaluate limited portions of a compacted material. Further, these methods may be time consuming as they are usually conducted separate from the compaction process. Therefore, there is a need for improved compaction monitoring systems that may allow real-time compaction measurement and can be used to evaluate large regions of the compacted material.

One system for monitoring compaction is described in U.S. Pat. No. 6,122,601 (“the '601 patent”), to Swanson et al., issued Sep. 19, 2000. The '601 patent describes a compactor that monitors compaction density and includes a three-dimensional positioning system to track the location and movement of the compactor. The compaction process may be monitored based upon the position of the compactor and the recorded movement of the compactor over the compacted surface.

The compaction system described in the '601 patent uses a vibration system to determine compaction density. The vibration system assumes that as the compacted material becomes more dense, the vibratory response of the compactor increases. However, the accuracy of this system is dependent upon the assumptions used to formulate the algorithms of the vibration system. Further, materials exhibiting dynamic vibrational responses may not correlate with the ability of the material to statically and rigidly support loads.

The compaction system and methods of the present disclosure are directed towards overcoming one or more of the problems as set forth above.

### SUMMARY OF THE INVENTION

One aspect of the present disclosure is directed toward a compaction monitoring system for a compactor. The compaction monitoring system includes one or more sensors configured to transmit signals representative of one or more characteristics of a material related to a compaction value of the material. The compaction monitoring system also includes a positioning system configured to transmit a location signal representative of a position of the compactor. The compaction monitoring system further includes a controller configured to receive the signals from the one or more sensors, determine compaction values of the material based on the signals from the one or more sensors using a proof-rolling method, and determine the position of the compactor based on the location signal transmitted by the positioning system. The controller may also be configured to generate a compaction value profile based on compaction values of the material and the position of the compactor, compare the compaction value profile to stored compaction value target information, determine a difference between the compaction value profile and the compaction value target information, and output information based on the difference between the compaction value profile and the compaction value target information.

Another aspect of the present disclosure is directed to a method for monitoring a compaction process. The method includes receiving signals from one or more sensors representative of one or more characteristics of a material related to a compaction value of the material. The method also includes determining compaction values of the material based on the signals from the one or more sensors using a proof-rolling method and a position of a compactor based on a location signal transmitted by a positioning system. A compaction value profile may be generated based on compaction values of the material and the position of the compactor, and compared to stored compaction value target information. The method determines a difference between the compaction value profile and the compaction value target information, and outputs information based on the difference between the compaction value profile and the compaction value target information.

### BRIEF DESCRIPTION OF THE DRAWINGS

FIG. 1 is a diagrammatic representation of a compactor, according to an exemplary embodiment.

FIG. 2 is a block diagram representation of a compaction monitoring system, according to an exemplary embodiment.

FIG. 3 is a diagrammatic representation of a display unit of a compaction monitoring system, according to an exemplary embodiment.

### DETAILED DESCRIPTION

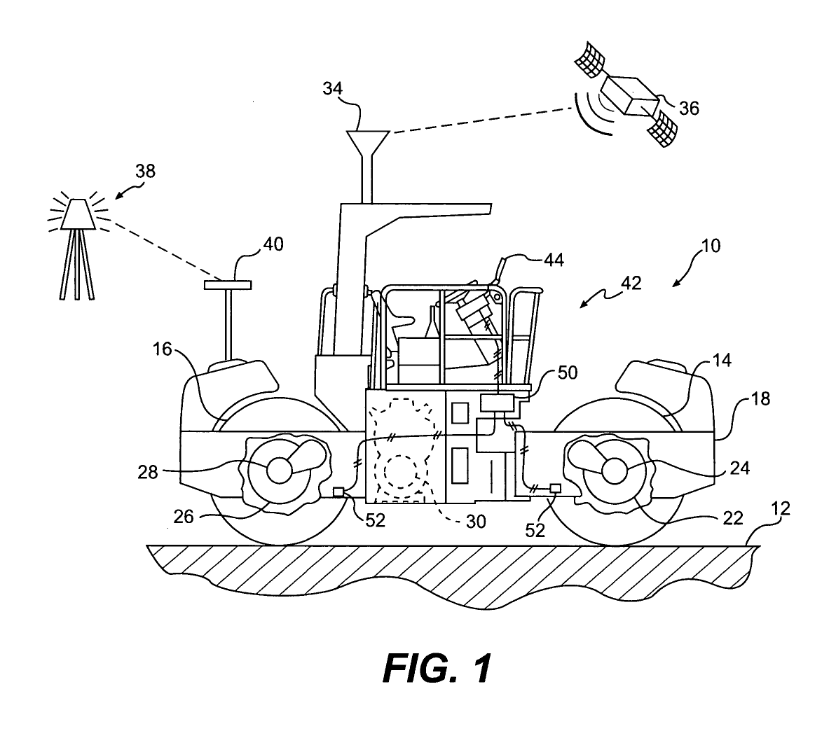

FIG. 1 is a diagrammatic representation of a compactor 10, according to an exemplary embodiment. Compactor 10 may include a frame 18, an engine 30, a first compacting drum 14, a second compacting drum 16, and a compaction monitoring system (CMS) 42. Compactor 10 may refer to any type of machine for compacting a material 12, such as, for example, soil, sand, gravel, loose bedrock, asphalt, recycled concrete, bituminous mixtures, or any other compactable material. For example, compactor 10 may include a rolling compactor, a plate compactor, a self-propelled compactor, a compactor towed behind a paving machine, or any compaction device known in the art. An exemplary embodiment shown in FIG. 1 illustrates a self-propelled, rolling compactor.

Engine 30 may by supported by frame 18 and may be configured to provide mechanical and/or electrical power to compactor 10. Engine 30 may include a variety of suitable engine types. For example, engine 30 may include an internal combustion engine, an electric generator, a fluid pump, or any other suitable device configured to propel compactor 10.

Engine 30 may be configured to provide power to components of compactor 10, such as a first motor 24, a second motor 28, and/or other systems of compactor 10. First and second motors 24, 28 may be operably coupled to engine 30 via electrical wires, fluid conduits, or any other suitable connection. Where engine 30 provides electrical power, first and second motors 24, 28 may be electric motors. Alternatively, where engine 30 provides hydraulic power, first and second motors 24, 28 may be fluid motors.

Compactor 10 may include various systems and/or devices configured to compact material 12. For example, compactor 10 may include one or more compacting drums 14, 16 rotatably mounted on frame 18. First compacting drum 14 and second compacting drum 16 may include first and second vibratory mechanisms 22, 26, which may be operatively connected to one or more motors 24, 28. First motor 24 may drive first compacting drum 14, and second motor 28 may drive second compacting drum 16. Compactor 10 may include fewer or additional components designed to compact material 12.

In an exemplary embodiment, as shown in FIG. 1, compactor 10 may include two compacting drums 14, 16, two vibratory mechanisms 22, 26, and two motors 24, 28. However, compactor 10 may include any suitable number of compacting drums, vibratory mechanisms, and/or motors. For example, compactor 10 may include one compacting drum and no vibratory mechanism. Further, compacting drums 14, 16 may include various surface configurations to facilitate compaction of material 12. For example, the surface of compacting drums 14, 16 may be generally smooth and/or include a studded surface.

CMS 42 may be configured to monitor the compaction of material 12 by compactor 10 during the compaction process. Further, CMS 42 may be configured to determine a compaction value (CV) of material 12, wherein the CV may include a measure of density, stiffness, modulus, or any other parameter representative of a compaction state of material 12 known in the art. CMS 42 may also be configured to use one or more compaction value targets (CVTs) of material 12.

CVTs may be selected based on the type of material being compacted, the conditions of the material being compacted, and/or other job-specific parameters. For example, a highway may require a certain CVT, and a secondary road may require a different CVT. Further, CVTs may be absolute or relative in value. Specifically, a relative CVT may be defined relative to a region of material 12 of known CV, and an absolute CVT may be defined in one or more units based on a standard scale of measurement. It is also contemplated that a range of CVTs may be selected for material 12. For example, CVT for material 12 may include an upper CVT and/or a lower CVT.

CMS 42 may include a variety of different devices configured to determine a CV of material 12 using a proof-rolling method. Proof-rolling methods may include any method for monitoring an interaction between compactor 10 and material 12 wherein the physical deformation of material 12 may be determined. For example, proof-rolling methods may include methods to determine an amount of energy transferred or consumed when compactor 10 moves over material 12, an effective roller (or drum) radius, a measurement of a rut depth caused by compactor 10, or any other suitable process for determining a sinkage deformation interaction between compactor 10 and material 12. In some embodiments, energy transfer may be determined by monitoring a level of energy delivered to material 12 or determining the propelling power consumed in moving compactor 10 over material 12. In other embodiments, the effective roller radius may be defined as the distance traveled by compactor 10 per roller revolution divided by two pi. The effective roller radius may be smaller than the actual roller radius if material 12 is relatively soft, and may increase and approach the actual roller radius as material 12 is compacted.

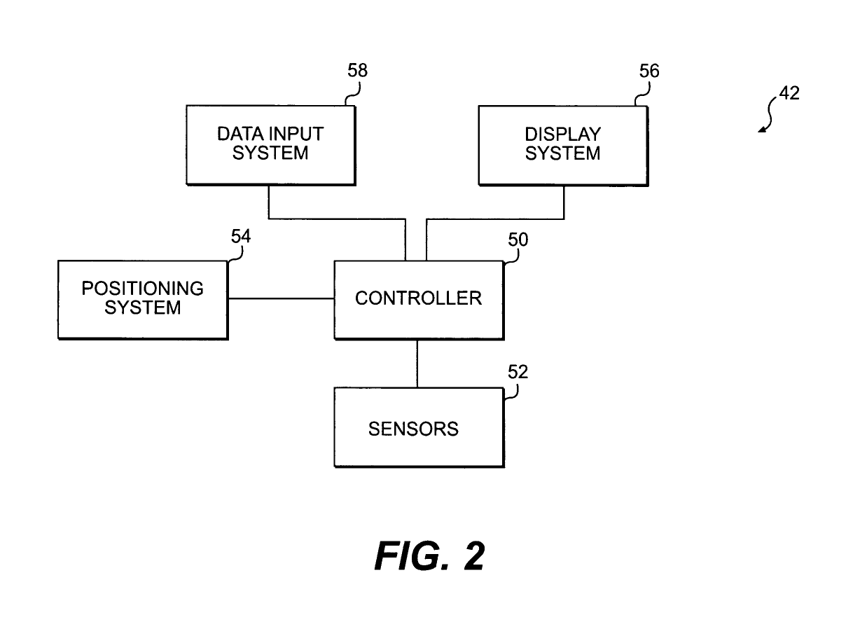

FIG. 2 shows a block level diagram of an exemplary embodiment of CMS 42. As shown, CMS 42 may include a positioning system 54, one or more sensors 52, a data input system 58, a display system 56, and a controller 50. CMS 42 may determine a position of compactor 10 based on a signal received from positioning system 54 and may determine a CV of material 12 based on a signal received from one or more sensors 52. CMS 42 may also receive data representing a CVT of material 12 from data input system 58. Further, CMS 42 may display information representing a CV and/or a CVT of material 12 using display system 56. In some embodiments, CMS 42 may be configured to at least partially control the operation of compactor 10 to vary the compaction of material 12.

CMS 42 may include a variety of different systems and/or devices configured to determine a position of compactor 10. The position of compactor 10 may be determined relative to a topographical feature, a coordinate system, and/or a region of operation of compactor 10. In an exemplary embodiment, the position of compactor 10 may be determined relative to material 12.

As noted, CMS 42 may include positioning system 54, which may be configured to determine a position of compactor 10. Positioning system 54 may include a variety of different positioning system types and/or configurations. For example, positioning system 54 may include components of a global positioning system (GPS). The GPS may include one or more GPS receivers 34, as shown in FIG. 1, configured to receive positional information from one or more satellites 36. Alternatively, positioning system 54 may include any other suitable positioning system. Positioning system 54 may include a laser-based positioning system, an Advanced Tracking Sensor (Trimble Engineering and Construction, Dayton, Ohio) and/or any other suitable positioning system known in the art. For example, compactor 10 may include components of a laser-based positioning system such as a laser transmitter 38 and/or a laser receiver 40 (FIG. 1).

Positioning system 54 may be configured to transmit a signal representative of a position of compactor 10. In particular, positioning system 54 may transmit any suitable type of signal, such as, for example, an analog or a digital electrical signal. The signal transmitted by positioning system 54 may be representative of a position of compactor 10 and/or may permit one or more components of CMS 42 to determine a position of compactor 10.

CMS 42 may include one or more sensors 52 configured to monitor a CV of material 12. In some embodiments, sensors 52 may be configured to monitor one or more parameters required to determine a CV of material 12 using a proof-rolling method. For example, sensors 52 may include devices configured to monitor drum rotation, ground clearance, energy interaction between compactor 10 and material 12, and/or any other parameters required to determine a CV of material 12 using a proof-rolling method. Sensors 52 may include non-contact and/or contact sensors, such as, for example, sonic sensors, infrared sensors, radar sensors, moisture sensors, accelerometers, gage wheels, or any other suitable monitoring devices known in the art.

Sensors 52 may be configured to transmit a signal representative of a CV of material 12. In particular, sensors 52 may transmit any suitable type of signal, such as, for example, an analog or a digital electrical signal. The signal transmitted from sensors 52 may be representative of a CV of material 12 and/or may permit one or more components of CMS 42 to determine a CV of material 12.

CMS 42 may be used to compact material 12 to one or more CVTs. CVTs and/or other data may be input into CMS 42 using a variety of different devices and/or methods known in the art. For example, CMS 42 may include data input system 58. Data input system 58 may be configured to receive data associated with CVTs, material 12, and/or any data related to the operation of compactor 10. In other embodiments, CVTs may be transmitted to CMS 42 from a remote source using any suitable wireless protocols.

Data input system 58 may include any suitable type of system configured to receive data. In particular, data input system 58 may include data input devices mounted on compactor 10, such as, for example, a keypad, a dial, an electronic tablet, a graphical user interface (GUI), or any other data input device known in the art. It is also contemplated that data may be input into CMS 42 using display unit 44. In other embodiments, data may also be prepared off site and input into CMS 42 using data input system 58. For example, data input system 58 may include a USB connection, a receptacle for receiving a memory storage device, a computer port, or any other data input device known in the art.

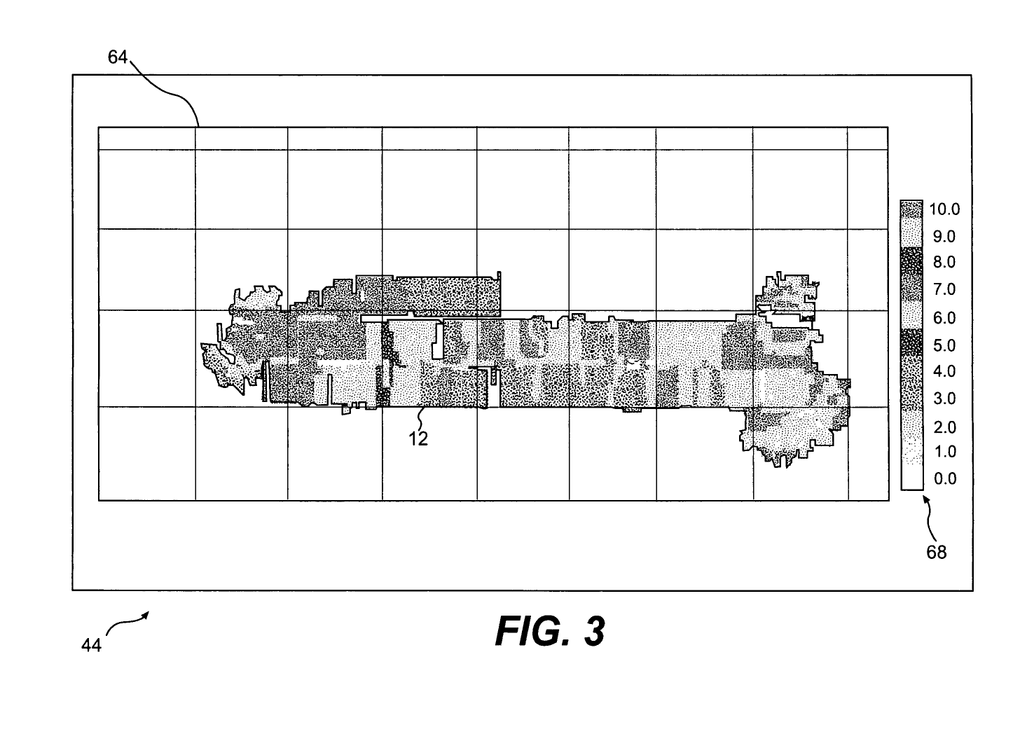

CMS 42 may include a variety of systems and/or devices to display information. In some embodiments, CMS 42 may include display system 56. Display system 56 may be configured to display information associated with compactor 10 and/or material 12. For example, display system 56 may include a cathode-ray tube display, a flat-panel display, a liquid-crystal display, or any other device configured to display information. In particular, display system 56 may include display unit 44, as shown in FIG. 3. Display unit 44 may be configured to display information representative of one or more CVs and/or CVTs of material 12.

The information displayed by display system 56 may be used by an operator to visually inspect information associated with the operation of compactor 10 and/or compaction of material 12. For example, information associated with the position and/or operation of compactor 10 may be displayed. Alternatively or additionally, information associated with material 12 may be displayed, such as, for example, CV, CVT, topography, stiffness, depth, density, water content, temperature and any other suitable information associated with material 12.

CMS 42 may include controller 50 configured to monitor and/or control various components of CMS 42. For example, controller 50 may determine a CV of material 12 based on a signal received from one or more sensors 52. In some embodiments, controller 50 may determine a position of compactor 10 based on a signal received from positioning system 54. Further, controller 50 may output information representative of a CV and/or a CVT of material 12 to display system 56. In some embodiments, controller 50 may be configured to at least partially control an operation of compactor 10 to vary the compaction of material 12.

CMS 42 may be configured to operate in real-time. Real-time may include any time less than about one second, and more typically, shorter times, such as fifty milliseconds or less. For example, controller 50 may be configured to receive, process, and/or output information in real-time. The speed of controller 50 may be dependent on several factors including, such as, the clock speed of controller 50, the architecture of controller 50, and the memory of controller 50. In some embodiments, controller 50 may be configured to operate in real-time to determine a CV of material 12 and/or at least partially control an operation compactor 10 to vary the compaction of material 12.

Controller 50 may be embodied in a single microprocessor or multiple microprocessors configured to monitor and/or control a function of CMS 42. Numerous commercially available microprocessors can be configured to perform a function of controller 50. It should be appreciated that controller 50 could readily be embodied in a general microprocessor capable of controlling one or more functions of compactor 10. Controller 50 may include a memory, a secondary storage device, a processor, and any other suitable components. Various other circuits may be associated with controller 50. For example, controller 50 may include or be operatively connected to power supply circuitry, signal conditioning circuitry, solenoid driver circuitry, and/or any other types of suitable circuitry.

Controller 50 may be configured to receive and process a signal from one or more components of CMS 42. For example, controller 50 may be configured to receive a signal from one or more sensors 52 related to various characteristics of material 12. Controller 50 may be configured to determine a CV of material 12 based on the signal received from one or more sensors 52. In some embodiments, controller 50 may determine a CV of material 12 using an algorithm based on a proof-rolling method. Specifically, controller 50 may be configured to process a signal received from one or more sensors 52 using the algorithm to determine a CV of material 12. Further, sensors 52 and controller 50 may be configured to determine a CV of material 12 as compactor 10 moves over material 12. For example, a CV of material 12 may be determined by assessing the propelling power consumed in moving compactor 10 over material 12, wherein propelling power may be determined by a ground speed and a rolling resistance.

As noted above, controller 50 may be configured to receive and/or process a signal from positioning system 54. The signal transmitted by positioning system 54 may be representative of a position of compactor 10. Controller 50 may be configured to determine the position of compactor 10 based on the signal received from positioning system 54.

Controller 50 may be configured to correlate CV and position information to determine a CV profile of material 12. In some embodiments, controller 50 may determine a CV of material 12 and associate the CV with a position of material 12 based on the position of compactor 10. As compactor 10 moves over material 12, controller 50 may map a CV profile of material 12. Further, controller 50 may be configured to store the CV profile of material 12.

Controller 50 may also be configured to store information representing one or more CVTs of material 12, wherein different CVTs may be specified for different locations of material 12 within a worksite. In some embodiments, data input system 50 may transmit data representative of a CVT of material 12 to controller 50. In other embodiments, CVTs may be transmitted to controller 50 from a remote source using any suitable wireless protocols.

Controller 50 may be configured to compare the CV profile and CVT information of material 12. Specifically, controller 50 may determine a CV for a location of material 12 and compare the CV to stored CVT information for a similar location of material 12. Controller 50 may then determine the difference between the CV and the CVT information and output information based on the difference. In some embodiments, controller 50 may be configured to output CV, position, and/or CVT information to display system 56. In other embodiments, controller 50 may be configured to output information to at least partially control an operation of compactor 10.

In some embodiments, controller 50 may be configured to output information to one or more components of CMS 42. Specifically, controller 50 may be configured to output information based on the difference between the CV profile and the CVT information. For example, controller 50 may output information to display system 56 such that display system 56 may display information related to a CV of material 12, a position of compactor 10, and/or a CVT of material 12. Controller 50 may output information to display system 56 wherein the position of compactor 10 may be displayed relative to CV and/or CVT information.

In some embodiments, controller 50 may be configured to output information to at least partially control an operation of compactor 10. For example, controller 50 may be configured to at least partially control the compaction of material 12 by varying the amplitude and/or frequency of one or more vibratory mechanisms. As compactor 10 moves over a region of material 12 requiring significant compaction, where the CV may be significantly less than the CVT, controller 50 may increase possible compaction by suitable modification of the amplitude and/or frequency of one or more vibratory mechanisms. If compactor 10 moves over a region of material 12 requiring less compaction, controller 50 may reduce compaction by suitable modification of the vibratory mechanisms. In other embodiments, controller 50 may be configured to at least partially control the rotational speed and/or direction of a compacting drum. For example, controller 50 may increase the speed of compacting drums 14, 16 to reduce compaction of material 12 where the CV approximates the CVT.

As noted previously, CMS 42 may include display unit 44 to display information associated with the compaction of material 12. FIG. 3 is a diagrammatic representation of display unit 44 of CMS 42, according to an exemplary embodiment. As shown, display unit 44 may include a two-dimensional view 64 of material 12 showing one or more CVs. Various regions of material 12 may be color-coded, cross-hatched, or gray-scaled to indicate CVs of material 12. For example, a first CV for a first region of material 12 may be a first color and a second CV for a second region of material 12 may be a second color. The association between color and CV or CVT may be represented by a scale 68.

During the compaction of material 12, display unit 44 may update the CVs of material 12. For example, as the CV of material 12 is modified, the color of material 12 as represented on display unit 44 may change to indicate the modified CV. It is also contemplated that display unit 44 may display information associated with CVTs of material 12. For example, the color of material 12 may change as the CV of material 12 approaches a CVT of material 12. If the CV of material 12 is approximately equal to the CVT of material 12, display unit 44 may indicate material 12 with a specific color. An operator may use the visual information to control an operation of compactor 10 to minimize the difference between the CV and CVT of material 12.

It is contemplated that systems, devices and/or methods described above may include additional, fewer and/or different features than listed above. It is understood that the type and number of listed features are illustrative and not intended to be limiting.

### INDUSTRIAL APPLICABILITY

Compactor 10 may be used to compact material 12, such as, for example, sand, gravel, and asphalt. Compactor 10 may be of any suitable size depending upon compaction requirements. For example, compactor 10 may be a small unit suitable for compaction of trenches, a large size machine suitable for compaction of highway surfaces, or any other appropriate size.

In operation, CMS 42 may be used to compact material 12 to one or more CVTs using compactor 10. Multiple CVTs may be required depending upon material 12 and/or job specification. For example, a building site may require multiple CVTs for different regions of material 12 based upon the intended load-bearing capacity of the different regions of material 12. CMS 42 may reduce the time required to compact material 12 to one or more CVTs. Specifically, CMS 42 may determine CVs as compactor 10 moves over material 12. CMS 42 may also be used to determine CVs and/or CVTs for large regions of material 12.

Before beginning compaction of material 12, an operator may input CVT data into compactor 10 using data input system 58. For example, an operator may enter a CVT for a region of material 12 by selecting a region of a highway surface to be compacted and assigning a CVT based on state regulations. Alternatively, an operator may enter CVT data prepared remotely using data input system 58. For example, CVT data may be prepared using an off-site computer and stored on a memory storage device. An operator may then connect the memory storage device to data input system 58 to transmit the CVT data to controller 50. In other embodiments, CVTs may be transmitted to compactor 10 from a remote source using any suitable wireless protocols.

In operation, an operator may monitor the compaction of material 12 using CMS 42. Based on the information provided by CMS 42, an operator may control compactor 10 to minimize the difference between the CV and CVT of material 12. CMS 42 may determine CVs of material 12 as compactor 10 moves over material 12 using one or more proof-rolling methods as described previously. CMS 42 may display CV, position and/or CVT data to an operator of compactor 10 using display unit 44. An operator may then control compactor 10 based on the CVs and/or CVTs of material 12 displayed using display unit 44. For example, an operator may direct compactor 10 over a region of material 12 requiring additional compaction while avoiding a compacted region of material 12. It is also contemplated that an operator may vary the compaction of material 12 by varying the frequency and/or amplitude of one or more vibratory mechanisms.

In another exemplary embodiment, CMS 42 may at least partially control compactor 10 to vary the compaction of material 12. For example, an operator may control the speed and direction of compactor 10 and controller 50 may control other operations of compactor 10. Specifically, controller 50 may control an operation of compactor 10 based on the difference between the CV and CVT of material 12. For example, controller 50 may modify the vibration frequency and/or amplitude of one or more vibratory mechanisms of compactor 10 to minimize the difference between the CV and CVT of material 12.

It will be apparent to those having ordinary skill in the art that various modifications and variations can be made to the disclosed compactor without departing from the scope of the invention. Other embodiments of the invention will be apparent to those having ordinary skill in the art from consideration of the specification and practice of the invention disclosed herein. It is intended that the specification and examples be considered as exemplary only, with a true scope of the invention being indicated by the following claims and their equivalents.

What is claimed is:

1. A compaction monitoring system for a compactor, comprising:
one or more sensors configured to transmit signals representative of one or more characteristics of a material related to a compaction value of the material;
a positioning system configured to transmit a location signal representative of a position of the compactor;
a controller configured to:
receive the signals from the one or more sensors;
determine compaction values of the material based on the signals from the one or more sensors using a proof-rolling method;
determine the position of the compactor based on the location signal transmitted by the positioning system;
generate a compaction value profile based on compaction values of the material and the position of the compactor;
compare the compaction value profile to stored compaction value target information;
determine a difference between the compaction value profile and the compaction value target information;
output information based on the difference between the compaction value profile and the compaction value target information.

2. The compaction monitoring system of claim 1, wherein the proof-rolling method includes determining at least one of an energy interaction between the compactor and the material, an effective drum radius, and a rut depth.

3. The compaction monitoring system of claim 1, wherein the one or more sensors include at least one of a sonic sensor, an infrared sensor, a radar sensor, a moisture sensor, an accelerometer, and a gage wheel.

4. The compaction monitoring system of claim 1, wherein the positioning system includes at least one of a global positioning system receiver, a laser-based positioning system, and an advanced tracking sensor.

5. The compaction monitoring system of claim 1, wherein the compaction monitoring system further includes a data input system configured to transmit data representative of the compaction value target information to the controller.

6. The compaction monitoring system of claim 1, wherein the compaction monitoring system further includes a display system configured to receive information output from the controller and display at least one of the compaction value of the material, the position of the compactor, and the compaction value target information.

7. The compaction monitoring system of claim 1, wherein the controller is configured to at least partially control an operation of the compactor to minimize the difference between the compaction value profile and the compaction value target information.

8. The compaction monitoring system of claim 7, wherein the compactor includes one or more compacting drums and the controller is configured to at least partially control at least one of the one or more compacting drums.

9. The compaction monitoring system of claim 7, wherein the compactor includes one or more vibratory mechanisms and the controller is configured to at least partially control at least one of the one or more vibratory mechanisms.

10. A method for monitoring a compaction process, comprising:
receiving signals from one or more sensors representative of one or more characteristics of a material related to a compaction value of the material;
determining compaction values of the material based on the signals from the one or more sensors using a proof-rolling method;
determining a position of a compactor based on a location signal transmitted by a positioning system;
generating a compaction value profile based on compaction values of the material and the position of the compactor;
comparing the compaction value profile to stored compaction value target information;
determining a difference between the compaction value profile and the compaction value target information;
outputting information based on the difference between the compaction value profile and the compaction value target information.

11. The method of claim 10, wherein the proof-rolling method includes determining at least one of an energy interaction between the compactor and the material, an effective drum radius, and a rut depth.

12. The method of claim 10, wherein the one or more sensors include at least one of a sonic sensor, an infrared sensor, a radar sensor, a moisture sensor, an accelerometer, and a gage wheel.

13. The method of claim 10, wherein the positioning system includes at least one of a global positioning system receiver, a laser-based positioning system, and an advanced tracking sensor.

14. The method of claim 10, wherein the method further includes transmitting data representative of the compaction value target information from a data input system configured to transmit data representative of the compaction value target information.

15. The method of claim 10, wherein the method further includes outputting information to a display system configured to receive the output information and display at least one of the compaction value of the material, the position of the compactor, and the compaction value target information.

16. The method of claim 10, wherein the method further includes outputting information to at least partially control an operation of the compactor to minimize the difference between the compaction value profile and the compaction value target information.

17. The method of claim 16, wherein the compactor includes one or more compacting drums and the output information at least partially controls at least one of the one or more compacting drums.

18. The method of claim 16, wherein the compactor includes one or more vibratory mechanisms and the output information at least partially controls at least one of the one or more vibratory mechanisms.

19. A compactor, comprising:
a frame;
an engine operably connected to the frame;
one or more compaction devices operably connected to the frame;
one or more sensors configured to transmit signals representative of one or more characteristics of a material related to a compaction value of the material;
a positioning system configured to transmit a location signal representative of a position of the compactor;
a controller configured to:
receive the signals from the one or more sensors;
determine compaction values of the material based on the signals from the one or more sensors using a proof-rolling method;
determine the position of the compactor based on the location signal transmitted by the positioning system;
generate a compaction value profile based on compaction values of the material and the position of the compactor;
compare the compaction value profile to the stored compaction value target information;
determine a difference between the compaction value profile and the compaction value target information;
output information based on the difference between the compaction value profile and the compaction value target information.

20. The compactor of claim 19, wherein the proof-rolling method includes determining at least one of an energy interaction between the compactor and the material, an effective drum radius, and a rut depth.

21. The compactor of claim 19, wherein the one or more sensors include at least one of a sonic sensor, an infrared sensor, a radar sensor, a moisture sensor, an accelerometer, and a gage wheel.

22. The compactor of claim 19, wherein the positioning system includes at least one of a global positioning system receiver, a laser-based positioning system, and an advanced tracking sensor.

23. The compactor of claim 19, wherein the compactor further includes a data input system configured to transmit data representative of the compaction value target information to the controller.

24. The compactor of claim 19, wherein the compactor further includes a display system configured to receive information output from the controller and display at least one of the compaction value of the material, the position of the compactor, and the compaction value target information.

25. The compactor of claim 19, wherein the controller is configured to at least partially control an operation of the compactor to minimize the difference between the compaction value profile and the compaction value target information.

26. The compactor of claim 25, wherein the one or more compaction devices includes one or more compacting drums and the controller is configured to at least partially control at least one of the one or more compacting drums.

27. The compactor of claim 25, wherein the one or more compaction devices includes one or more vibratory mechanisms and the controller is configured to at least partially control at least one of the one or more vibratory mechanisms.
